(19) United States
(12) Patent Application Publication
(10) Pub. No.: US 2024/0275458 A1
(43) Pub. Date: Aug. 15, 2024

(54) CONFIRMATION TO IMPLICIT BEAM SWITCH

(71) Applicant: QUALCOMM Incorporated, San Diego, CA (US)

(72) Inventors: Fang YUAN, Beijing (CN); Yan ZHOU, San Diego, CA (US); Sony AKKARAKARAN, Poway, CA (US); Mahmoud TAHERZADEH BOROUJENI, San Diego, CA (US); Mostafa KHOSHNEVISAN, San Diego, CA (US); Tao LUO, San Diego, CA (US); Peter GAAL, San Diego, CA (US)

(21) Appl. No.: 18/568,721

(22) PCT Filed: Aug. 6, 2021
(86) PCT No.: PCT/CN2021/111241

§ 371 Date: Dec. 8, 2023

(51) Int. Cl. H04B 7/06; H04L 5/00

(52) U.S. Cl. CPC H04B 7/0626; H04L 5/005

(57) ABSTRACT

Methods, apparatuses, and computer readable medium for beam switch are provided. An example method may include transmitting, to a base station, a channel state information (CSI) report associated with a beam switch. The example method may further include performing the beam switch based on the CSI report and an absence, for a period of time after transmission of the CSI report, of a downlink control information (DCI) including a transmission configuration indicator (TCI) indication.

### TECHNICAL FIELD

The present disclosure relates generally to communication systems, and more particularly, to wireless communication with a beam switch.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to transmit, to a base station, a channel state information (CSI) report associated with a beam switch. The memory and the at least one processor coupled to the memory may be further configured to perform the beam switch based on the CSI report and an absence, for a period of time after transmission of the CSI report, of a downlink control information (DCI) including a transmission configuration indicator (TCI) indication.

In another aspect of the disclosure, a method, a computer-readable medium, and an apparatus at a UE are provided. The apparatus may include a memory and at least one processor coupled to the memory. The memory and the at least one processor coupled to the memory may be configured to transmit, to a base station, a CSI report associated with a beam switch. The memory and the at least one processor coupled to the memory may be further configured to perform the beam switch based on the CSI report and a reception of a DCI, within a period of time, confirming the beam switch indicated in the CSI report.

In another aspect of the disclosure, a method, a computer-readable medium, and an apparatus at a base station are provided. The apparatus may include a memory and at least one processor coupled to the memory. The memory and the at least one processor coupled to the memory may be configured to receive, from a UE, a CSI report associated with a beam switch. The memory and the at least one processor coupled to the memory may be further configured to perform the beam switch based on the CSI report without transmitting, for a period of time after transmission of the CSI report, a DCI including a TCI indication.

In another aspect of the disclosure, a method, a computer-readable medium, and an apparatus at a base station are provided. The apparatus may include a memory and at least one processor coupled to the memory. The memory and the at least one processor coupled to the memory may be configured to receive, from a UE, a CSI report associated with a beam switch. The memory and the at least one processor coupled to the memory may be further configured to transmit a DCI confirming the beam switch indicated in the CSI report. The memory and the at least one processor coupled to the memory may be further configured to perform the beam switch within a period of time.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A and 4B are diagrams illustrating a base station in communication with a UE via a set of beams.

FIG. 5 is a diagram illustrating a base station in communication with a UE via a set of beams.

FIG. 6 is a diagram illustrating a beam switch procedure.

FIGS. 7A and 7B are diagrams illustrating a beam switch procedure.

FIGS. 8A and 8B are diagrams illustrating a beam switch procedure.

FIG. 9 is a diagram illustrating a beam switch procedure.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus.

FIG. 15 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components, end-user devices, etc. of varying sizes, shapes, and constitution.

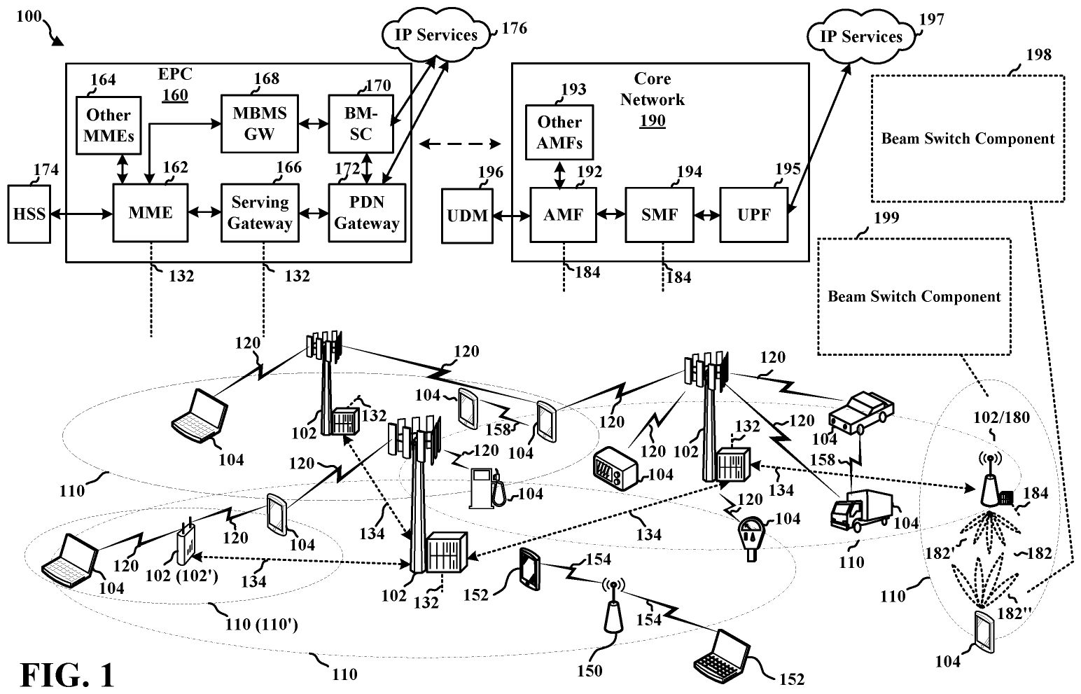

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogenous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHZ). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a beam switch component 198. In some aspects, the beam switch component 198 may be configured to transmit, to a base station, a CSI report associated with a beam switch. In some aspects, the beam switch component 198 may be further configured to perform the beam switch based on the CSI report and an absence, for a period of time after transmission of the CSI report, of a DCI including a TCI indication. In some aspects, the beam switch component 198 may be further configured to perform the beam switch based on the CSI report and a reception of a DCI, within a period of time, confirming the beam switch indicated in the CSI report.

In certain aspects, the base station 180 may include a beam switch component 199. In some aspects, the beam switch component 199 may be configured to receive, from a UE, a CSI report associated with a beam switch. In some aspects, the beam switch component 199 may be further configured to perform the beam switch based on the CSI report without transmitting, for a period of time after transmission of the CSI report, a DCI including a TCI indication. In some aspects, the beam switch component 199 may be further configured to transmit a DCI confirming the beam switch indicated in the CSI report and perform the beam switch within a period of time.

Although the following description may be focused on 5G NR, the concepts described herein may be applicable to other similar areas, such as LTE, LTE-A, CDMA, GSM, and other wireless technologies.

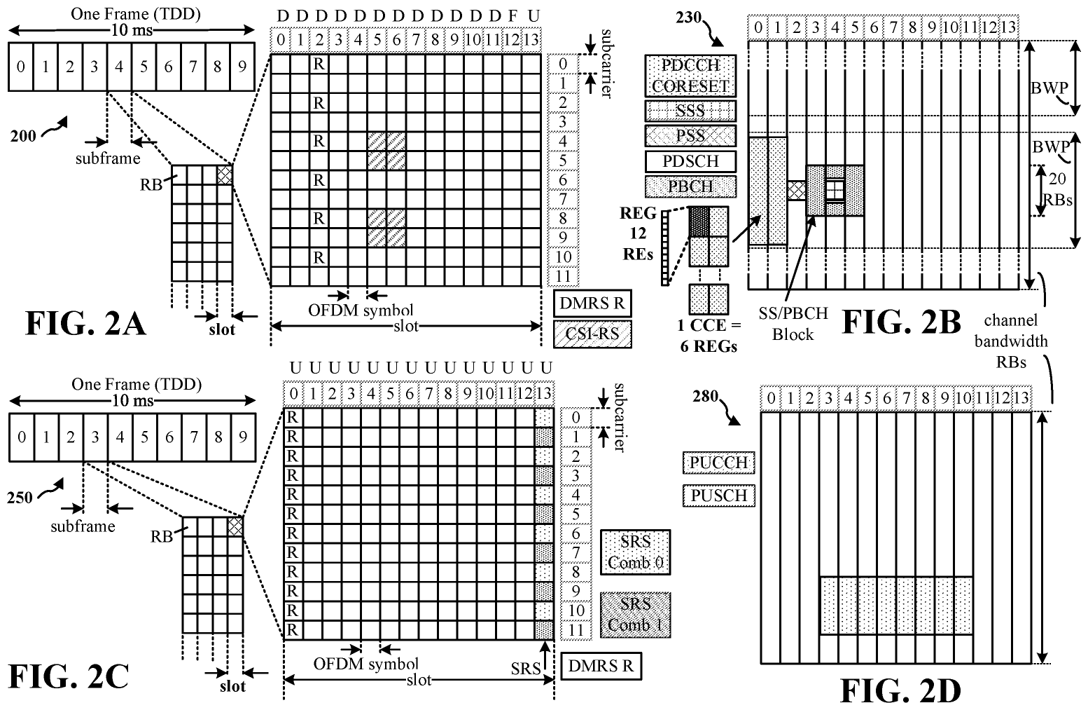

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ} *15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

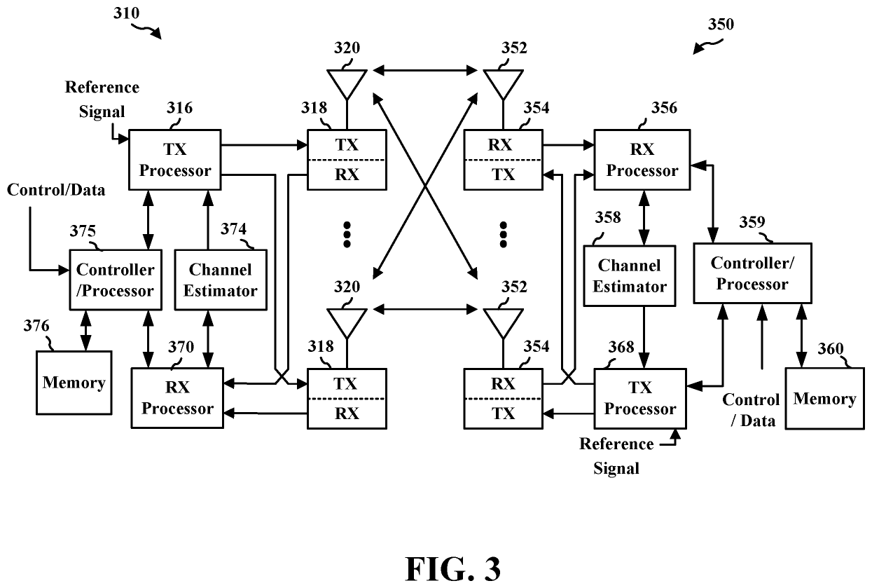

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the beam switch component 198 of FIG. 1.

At least one of the TX processor 316, the RX processor 370, and the controller/processor 375 may be configured to perform aspects in connection with beam switch component 199 of FIG. 1.

A UE may use a random access procedure in order to communicate with a base station. For example, the UE may use the random access procedure to request an radio resource control (RRC) connection, to re-establish an RRC connection, resume an RRC connection, etc. A UE may use a random access procedure in order to communicate with a base station. For example, the UE may use the random access procedure to request an RRC connection, to re-establish an RRC connection, resume an RRC connection, etc. Random Access Procedures may include two different random access procedures, e.g., The UE may use Contention Based Random Access (CBRA) may be performed when a UE is not synchronized with a base station, and the Contention Free Random Access (CFRA) may be applied, e.g., when the UE was previously synchronized to a base station 604. Both the procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access.

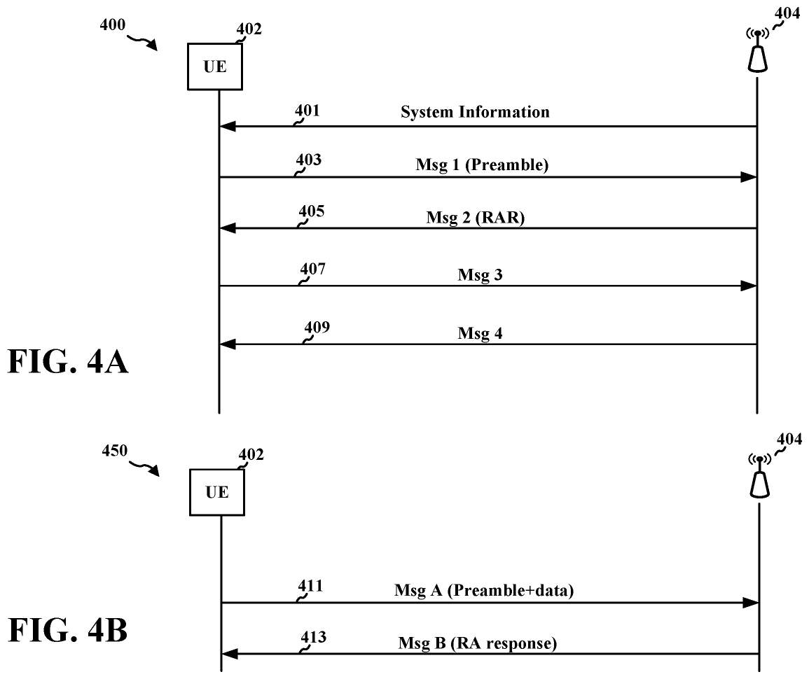

FIG. 4A illustrates example aspects of a random access procedure 400 between a UE 402 and a base station 404. The UE 402 may initiate the random access message exchange by sending, to the base station 404, a first random access message 403 (e.g., Msg 1) including a preamble. Prior to sending the first random access message 403, the UE may obtain random access parameters, e.g., including preamble format parameters, time and frequency resources, parameters for determining root sequences and/or cyclic shifts for a random access preamble, etc., e.g., in system information 401 from the base station 404. The preamble may be transmitted with an identifier, such as a Random Access RNTI (RA-RNTI). The UE 402 may randomly select a random access preamble sequence, e.g., from a set of preamble sequences. If the UE 402 randomly selects the preamble sequence, the base station 404 may receive another preamble from a different UE at the same time. In some examples, a preamble sequence may be assigned to the UE 402.

The base station may respond to the first random access message 403 by sending a second random access message 405 (e.g. Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the RAR 405, the UE 402 may transmit a third random access message 407 (e.g., Msg 3) to the base station 404, e.g., using PUSCH, that may include a RRC connection request, an RRC connection re-establishment request, or an RRC connection resume request, depending on the trigger for the initiating the random access procedure. The base station 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs sent a same preamble at 703, both UEs may receive the RAR leading both UEs to send a third random access message 407. The base station 404 may resolve such a collision by being able to decode the third random access message from only one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the base station 404 based on the RAR 409.

In order to reduce latency or control signaling overhead, a single round trip cycle between the UE and the base station may be achieved in a 2-step RACH process 450, such as shown in FIG. 4B. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. After the UE 402 transmits the Msg A 411, the UE 402 may wait for a response from the base station 404. Additionally, aspects of the Msg 2 and Msg 4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg 1. If the base station detects the Msg A, but fails to successfully decode the Msg A PUSCH, the base station may respond with an allocation of resources for an uplink retransmission of the PUSCH. The UE may fallback to the four step RACH with a transmission of Msg 3 based on the response from the base station and may retransmit the PUSCH from Msg A. If the base station successfully decodes the Msg A and corresponding PUSCH, the base station may reply with an indication of the successful receipt, e.g., as a random access response 413 that completes the two-step RACH procedure. The Msg B may include the random access response and a contention-resolution message. The contention resolution message may be sent after the base station successfully decodes the PUSCH transmission.

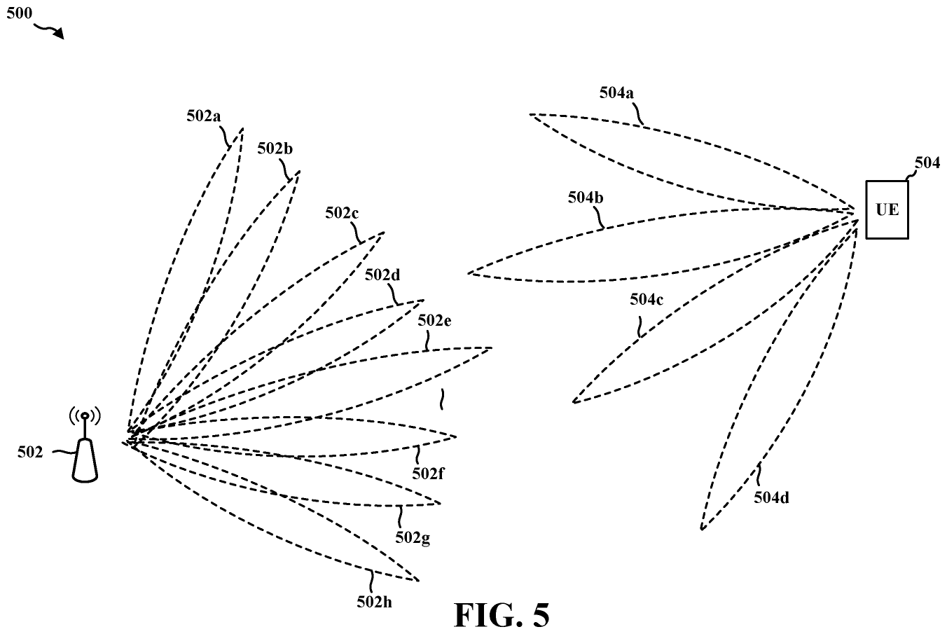

FIG. 5 is a diagram 500 illustrating a base station 502 in communication with a UE 504. Referring to FIG. 5, the base station 502 may transmit a beamformed signal to the UE 504 in one or more of the directions 502a, 502b, 502c, 502d, 502c, 502f, 502g, 502h. The UE 504 may receive the beamformed signal from the base station 502 in one or more receive directions 504a, 504b, 504c, 504d. The UE 504 may also transmit a beamformed signal to the base station 502 in one or more of the directions 504a-504d. The base station 502 may receive the beamformed signal from the UE 504 in one or more of the receive directions 502a-502h. The base station 502/UE 504 may perform beam training to determine the best receive and transmit directions for each of the base station 502/UE 504. The transmit and receive directions for the base station 502 may or may not be the same. The transmit and receive directions for the UE 504 may or may not be the same. The term beam may be otherwise referred to as “spatial filter”. Beamforming may be otherwise referred to as “spatial filtering”.

In response to different conditions, the UE 504 may determine to switch beams, e.g., between beams 502a-502h. The beam at the UE 504 may be used for reception of downlink communication and/or transmission of uplink communication. In some examples, the base station 502 may send a transmission that triggers a beam switch by the UE 504. A TCI state may include Quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the base station 502 may indicate a TCI state change, and in response, the UE 504 may switch to a new beam (which may be otherwise referred to as performing a beam switch) according to the new TCI state indicated by the base station 502.

In some wireless communication systems, such as a wireless communication system under a unified TCI framework, a pool of joint DL/UL TCI states may be used for joint DL/UL TCI state updates for beam indication. For example, the base station 502 may transmit a pool of joint DL/UL TCI states to the UE 504. The UE 504 may determine to switch transmission beams and/or reception beams based on the joint DL/UL TCI states. In some aspects, the TCI state pool for separate DL and UL TCI state updates may be used. In some aspects, the base station 502 may use RRC signaling to configure the TCI state pool. In some aspects, the joint TCI may or may not include UL specific parameter(s) such as UL PC/timing parameters, PLRS, panel-related indication, or the like. If the joint TCI includes the UL specific parameter(s), the parameters may be used for the UL transmission of the DL and UL transmissions to which the joint TCI is applied.

Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 5 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like.

A TCI state may be defined to represent at least one source RS to provide a reference (e.g., UE assumption) for determining quasi-co-location (QCL) or spatial filters. For example, a TCI state may define a QCL assumption between a source RS and a target RS.

To accommodate situations where beam indication for UL and DL are separate, two separate TCI states (one for DL and another one for UL) may be utilized. For a separate DL TCI, the source reference signal(s) in M (M being an integer) TCIs may provide QCL information at least for UE-dedicated reception on PDSCH and for UE-dedicated reception on all or subset of CORESETs in a CC. For a separate UL TCI, the source reference signal(s) in N (N being an integer) TCIs provide a reference for determining common UL transmission (TX) spatial filter(s) at least for dynamic-grant or configured-grant based PUSCH and all or subset of dedicated PUCCH resources in a CC.

In some aspects, the UL TX spatial filter may also apply to all SRS resources in resource set(s) configured for antenna switching, codebook-based, or non-codebook-based UL transmissions.

In some aspects, each of the following DL RSs may share the same indicated TCI state as UE-dedicated reception on PDSCH and for UE-dedicated reception on all or subset of CORESETs in a CC: CSI-RS resources for CSI, some or all CSI-RS resources for beam management, CSI-RS for tracking, and DM-RS(s) associated with UE-dedicated reception on PDSCH and all/subset of CORESETs. Some SRS resources or resource sets for beam management may share the same indicated TCI state as dynamic-grant/configured-grant based PUSCH, all or subset of dedicated PUCCH resources in a CC. In some wireless communication systems, several QCL rules may be defined. For example, a first rule may define that TCI to DM-RS of UE dedicated PDSCH and PDCCH may not have SSB as a source RS to provide QCL type D information. A second rule may define that TCI to some DL RS such as CSI-RS may have SSB as a source RS to provide QCL type D information. A third rule may define that TCI to some UL RS such as SRS can have SSB as a source RS to provide spatial filter information. Example aspects provided herein enable a UE to signal capability of applying unified TCI to RS, provide QCL indication to DL RS, and provide hybrid spatial filter indication to UL RS.

In some wireless communication systems, to facilitate a common TCI state ID update and activation to provide common QCL information at least for UE-dedicated PDCCH/PDSCH (e.g., common to UE-dedicated PDCCH and UE-dedicated PDSCH) or common UL TX spatial filter(s) at least for UE-dedicated PUSCH/PUCCH across a set of configured CCs/BWPs (e.g., common to multiple PUSCH/PUCCH across configured CCs/BWPs), several configurations may be provided. For example, the RRC-configured TCI state pool(s) may be configured as part of the PDSCH configuration (such as in a PDSCH-Config parameter) for each BWP or CC. The RRC-configured TCI state pool(s) may be absent in the PDSCH configuration for each BWP/CC, and may be replaced with a reference to RRC-configured TCI state pool(s) in a reference BWP/CC. For a BWP/CC where the PDSCH configuration contains a reference to the RRC-configured TCI state pool(s) in a reference BWP/CC, the UE may apply the RRC-configured TCI state pool(s) in the reference BWP/CC. When the BWP/CC identifier (ID) (e.g., for a cell) for QCL-Type A or Type D source RS in a QCL information (such as in a QCL info parameter) of the TCI state is absent, the UE may assume that QCL-Type A or Type D source RS is in the BWP/CC to which the TCI state applies. In addition, a UE may report a UE capability indicating a maximum number of TCI state pools that the UE can support across BWPs and CCs in a band.

Before receiving a TCI state, a UE may assume that the antenna ports of one DM-RS port group of a PDSCH are spatially QCL′d with an SSB determined in the initial access procedure with respect to one or more of: a Doppler shift, a Doppler spread, an average delay, a delay spread, a set of spatial Rx parameters, or the like. After receiving the new TCI state, the UE may assume that the antenna ports of one DM-RS port group of a PDSCH of a serving cell are QCL′d with the RS(s) in the RS set with respect to the QCL type parameter(s) given by the indicated TCI state. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, a maximum number of TCI states may be 128.

In some aspects, a UE may receive a signal, from a base station, configured to trigger a TCI state change via, for example, a medium access control (MAC) control element (CE) (MAC-CE), a downlink control information (DCI), or a radio resource control (RRC) signal. The TCI state change may cause the UE to find the best or most suitable UE receive beam corresponding to the TCI state indicated by the base station, and switch to such beam. Switching beams may allow for an enhanced or improved connection between the UE and the base station by ensuring that the transmitter and receiver use the same configured set of beams for communication.

In some aspects, a spatial relation change, such as a spatial relation update, may trigger the UE to switch beams. Beamforming may be applied to uplink channels, such as a PUSCH, a PUCCH, or an SRS, or downlink channels, such as PDCCH, PDSCH, or the like. Beamforming may be based on configuring one or more spatial relations between the uplink and downlink signals. Spatial relation indicates that a UE may transmit the uplink signal using the same beam used for receiving the corresponding downlink signal.

To facilitate more efficient beam refinement and tracking, in some aspects, UE initiated beam selection or activation based on beam measurement at a UE without a beam indication or activation from the network. In some aspects, a beam switch that may be triggered by a UE based on various measurements or reports related to a beam and may be independent of a beam activation or indication from a base station. For example, a UE may receive a CSI report with a beam index from a base station and the UE may trigger an implicit beam switch based on the CSI report. The term “implicit beam switch” may refer to a UE initiated beam selection or activation without explicit beam indication or activation from the network. By utilizing such implicit beam switch, latency associated with beam switch may be reduced. Signaling overhead may also be reduced.

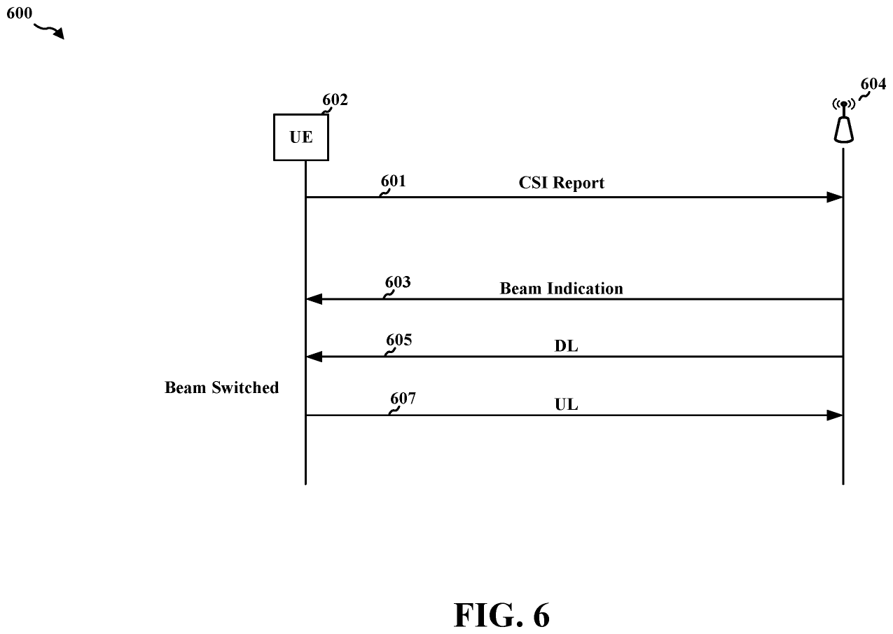

FIG. 6 is a diagram 600 illustrating a beam switch procedure. As illustrated in FIG. 6, a UE 602 may transmit a CSI report 601 to the base station 604. For monitoring active link performances, the UE 602 may perform measurements of at least one signal, e.g., reference signals, of one or more beams. The measurements may include deriving a metric similar to a Signal to Interference plus Noise Ratio (SINR) for the signal, or RSRP strength or block error rate (BLER) of a reference control channel, e.g., based on an RRC configuration. The reference signal may comprise any of CSI-RS, Physical Broadcast Channel (PBCH), a synchronization signal, or other reference signals for time and/or frequency tracking, etc. In some cases, the UE may determine a configured metric such as block error rate (BLER) for a reference signal for the one or more beams. The measurement(s) may indicate the UE's ability to exchange communication with the base station 604 using the beam. In some aspects, the measurements may indicate that a current beam has a lower quality than a different beam. The UE 602 may indicate the new beam to the base station 604. For example, the CSI report 601 may include a field representing a UE preferred that is different than a current beam. For example, the field representing the UE preferred beam may be a beam index. Based on the CSI report 601, the UE 602 and the base station 604 may perform beam switching, for downlink channels 605 and uplink channels 607. In some aspects, the base station 604 may also generate and transmit a beam indication 603. In some other aspects, the base station 604 may not transmit a beam indication 603. The beam switch performed for the downlink channels 605 and the uplink channels 607 may be independent of the beam indication 603.

Because a UE-initiated implicit beam switch may be performed, or indicated, independent of base station signaling for the beam switch, the UE initiated implicit beam switch may be associated with a UE preferred beam that may be improper for the base station. Aspects provided herein improve the reliability of the UE initiated implicit beam switch by supporting an implicit or explicit confirmation for the implicit beam switch.

In some aspects, an implicit beam indication confirmation for an UE-initiated, implicit beam switch may be supported. For example, after transmitting a CSI report indicating the implicit beam switch, UE may apply the implicit beam switch based on the CSI report, if within a time offset after the CSI report, the UE does not receive: 1) a DCI with a new TCI indication that targets at a set of channels and/or RSs same as the set of channels and/or RSs targeted by the unified TCI corresponding to the RS selected in the CSI report for implicit beam switch, where the two TCIs may be different; 2) a DCI with a new TCI indication which targets at any of the channels and/or RSs applicable to the unified TCI corresponding to the RS selected in the CSI report for implicit beam switch; and/or 3) a DCI with dedicated fields or explicit bits rejecting the implicit beam switching. For example, for a layer 1 (L1) beam report used for implicit beam switch, the unified TCI state corresponding to the RS with a best reported metric may be applied to all applicable channels/RSs of the unified TCI state if no TCI updating DCI is received within X millisecond (ms) or slots after the end of the L1 beam report. For another example, for a layer 1 (L1) beam report used for implicit beam switch, the unified TCI state corresponding to the RS with a best reported metric may be applied to all applicable channels/RSs of the unified TCI state, if no DCI is received within X ms or slots after the end of the L1 beam report for indicating a different unified TCI but for the same set of applicable channels/RSs of the unified TCI state corresponding to the RS with a best reported metric in the L1 beam report.

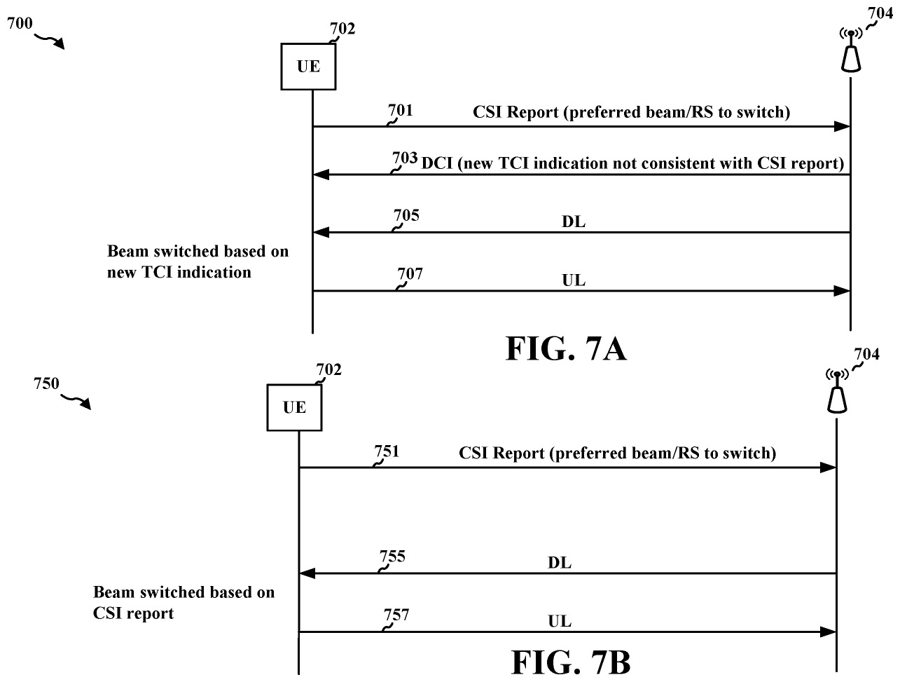

FIG. 7A is a diagram 700 illustrating a UE-initiated beam switch procedure based on the absence of a different TCI indication from a base station. As illustrated in FIG. 7A, the UE 702 may transmit a CSI report 701 to the base station 704. The CSI report 701 may be a CSI report that may indicate a beam for an implicit beam switch. After receiving the CSI report 701, the base station 704 may determine that the beam indicated in the CSI report 701 may be improper for the base station 704. After determining that the beam indicated in the CSI report 701 may be improper for the base station 704, the base station 704 may transmit a DCI 703 to the UE 702. The DCI 703 may indicate a new TCI indication associated with a new beam that may be different from the beam indicated in the CSI report 701. There may be at least one channel or RS applicable to both the beams or TCIs. The UE 702 and the base station 704 may accordingly perform beam switching based on the new TCI indication associated with the new beam indicated in the DCI 703 for downlink channels 705 or uplink channels 707, and cancel the beam switching based on implicit beam switch in the CSI report 701.

FIG. 7B is a diagram 750 illustrating a beam switch procedure. As illustrated in FIG. 7B, the UE 702 may transmit a CSI report 751 to the base station 704. The CSI report 751 may be a CSI report that may indicate a beam for an implicit beam switch. After receiving the CSI report 751, the base station 704 may determine that the beam indicated in the CSI report 751 may be proper for the base station. After determining that the beam indicated in the CSI report 751 may be proper for the base station 704, the base station 704 may skip transmission of a DCI with new TCI indication or rejection. In some aspects, the base station 704 may skip sending a DCI in response to the CSI report as a way of confirming the new beam indicated in the CSI report. After a period of time, the UE 702 and the base station 704 may perform beam switching based on the beam indicated in the CSI report 751 for one or more downlink channels 755 or uplink channels 757 which are the applicable channels of the unified TCI corresponding to the RS selected in the CSI report 751. For example, the UE 702 may transmit uplink communication to the base station 704 based on the new beam indicated in the CSI report and/or may receive downlink communication based on the new beam indicated in the CSI report 751. Likewise, the base station 704 may receive uplink communication from the UE 702 based on the new indicated in the CSI report 751 and may transmit downlink communication based on the new beam indicated in the CSI report 751.

In some aspects, instead of performing a beam switch based on an absence of a DCI not consistent with the CSI report, the UE and the base station may perform beam switch based on a DCI confirming the beam switch indicated in the CSI report. For example, after transmitting a CSI report that indicates an implicit beam switch, the UE may apply the implicit beam switch based on the CSI report if the UE receives a confirmation DCI within a time offset following transmission of the CSI report. In some aspects, the confirmation DCI may be a DCI indicating a unified TCI same as the unified TCI corresponding to the RS selected in the CSI report for implicit beam switch. For example, for a L1 beam report used for implicit beam switch, the unified TCI state corresponding to the RS with the best reported metric may be applied to all applicable channels/RSs of the unified TCI state if a TCI updating DCI indicating the same unified TCI corresponding to the RS is received within X ms or slots after the end of the L1 beam report. In some aspects, the confirmation DCI may be a DCI with dedicated fields or explicit bits confirming the implicit beam switch. To reduce the beam switching latency, if a confirmation DCI is received, the application time (or timing offset) of the unified TCI for implicit beam switch may start from the end of the CSI report transmission. For example, if a confirmation DCI is received within a first time offset (e.g., X ms or slots) from the end of the CSI report transmission, the UE may apply the beam to the corresponding applicable channels for the implicit beam switch starting from a second time offset (e.g., Y ms or slots, as the application time) from the end of the CSI report transmission, where the value of Y may larger than the value of X. In some other aspects, to reduce the beam switching latency, if a confirmation DCI is received, the application time (or timing offset) of the unified TCI for implicit beam switch may start from the end of the confirmation DCI. For example, if a confirmation DCI is received within a first time offset (e.g., X ms or slots) from the end of the CSI report transmission, the UE may apply the beam to the corresponding applicable channels for implicit beam switch starting from a second time offset (e.g., Y ms or slots, as the application time) from the end of the confirmation DCI.

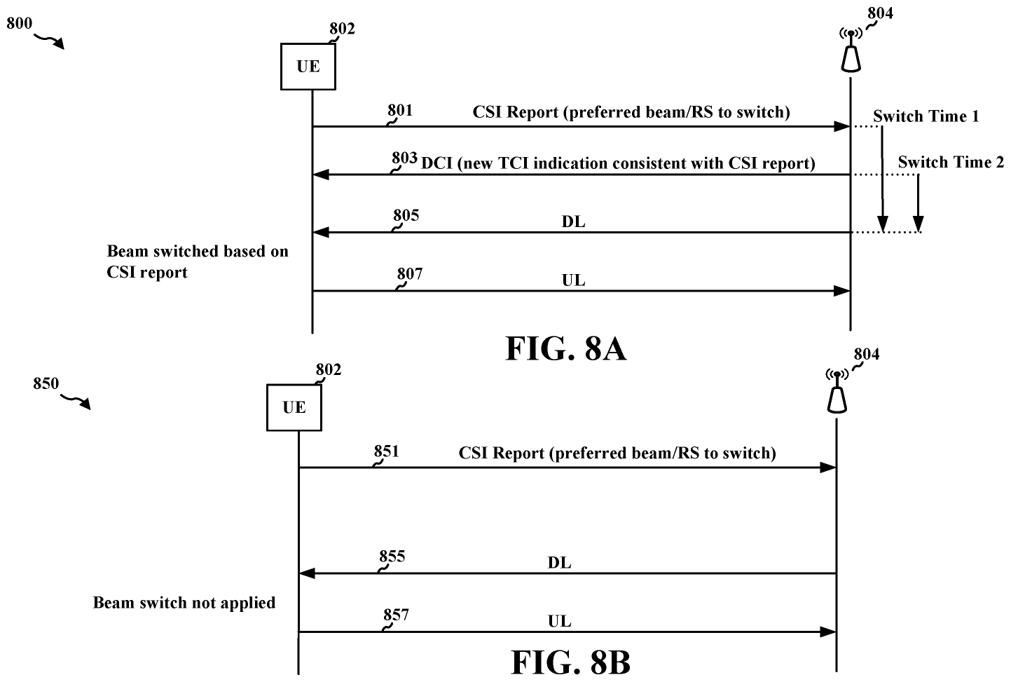

As one example, FIG. 8A is a diagram 800 illustrating a UE-initiated beam switch procedure based on a confirmation DCI. As illustrated in FIG. 8A, the UE 802 may transmit a CSI report 801 to the base station 804. The CSI report 801 may be a CSI report that may indicate a beam for an implicit beam switch, e.g., a new beam that is different from a current beam. After receiving the CSI report 801, the base station 804 may determine that the beam indicated in the CSI report 801 may be proper for the base station 804. After determining that the beam indicated in the CSI report 801 may be proper for the base station 804, the base station 804 may transmit a DCI 803 to the UE 802. The DCI 803 may indicate a TCI indication associated with a beam that may be the same as the beam indicated in the CSI report 801 and have a same set of applicable channels and/or RSs (e.g., the unified TCI indicated by the DCI 803 and the unified TCI corresponding to the CSI report 801 for implicit beam switch may be identical), thereby confirming the beam indicated in the CSI report. The UE 802 and the base station 804 may accordingly perform beam switching based on the beam indicated in the CSI report 801 for downlink channels 805 or uplink channels 807 after a time offset. The application time or time offset for the beam switching may be calculated based on the transmission of the CSI report 801 or transmission of the DCI 803.

As another example, FIG. 8B is a diagram 850 illustrating a beam switch procedure. As illustrated in FIG. 8B, the UE 802 may transmit a CSI report 851 to the base station 804. The CSI report 851 may be a CSI report for an implicit beam switch that may indicate a beam. After receiving the CSI report 851, the base station 804 may determine that the beam indicated in the CSI report 851 may be improper for the base station 804. After determining that the beam indicated in the CSI report 851 may be improper for the base station 804, the base station 804 may refrain from transmitting a confirmation DCI to the UE 802. Therefore, the UE 802 and the base station 804 may accordingly refrain from performing beam switching based on the beam indicated in the CSI report 851 for downlink channels 855 or uplink channels 857.

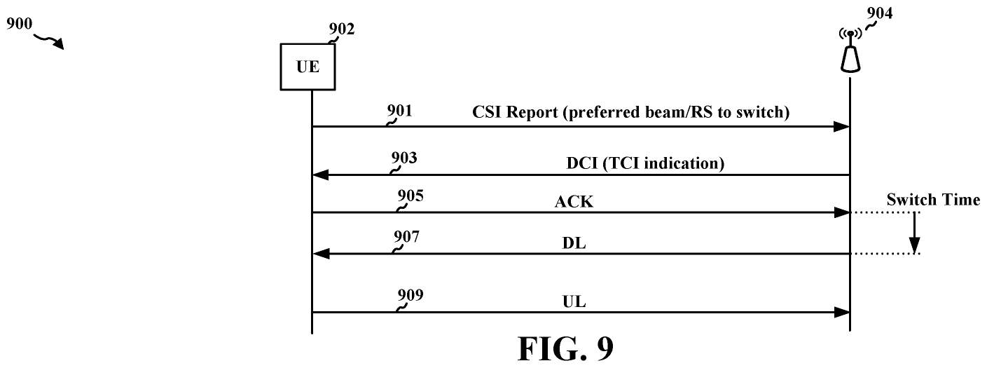

FIG. 9 is a diagram 900 illustrating a beam switch procedure. As illustrated in FIG. 9, the UE 902 may transmit a CSI report 901 to the base station 904. The CSI report 901 may be a CSI report that may indicate a beam for a beam switch. The base station 904 may transmit a DCI 903 including a TCI indication consistent with the CSI report 901, where the TCI indicated by DCI 903 and the TCI corresponding the CSI report 901 have a same beam and a same set of applicable channels. The UE 902 may transmit an acknowledgment (ACK) 905 after receiving the DCI 903. After transmitting the ACK 905 then after a time offset from the end of CSI report 901, from the end of DCI 903 or from the end of ACK 905, the UE 902 and the base station 904 may perform a beam switch for downlink channels 907 and uplink channels 909 based on the CSI report 901 for implicit beam switch.

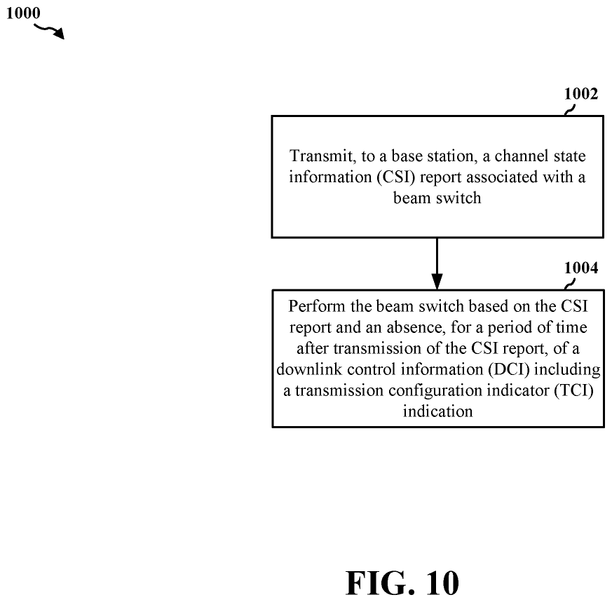

FIG. 10 is a flowchart 1000 of a method of wireless communication. The method may be performed by a UE (e.g., the UE 104, the UE 802, other UEs; the apparatus 1402). The method may be used for improving reliability of an implicit beam switch.

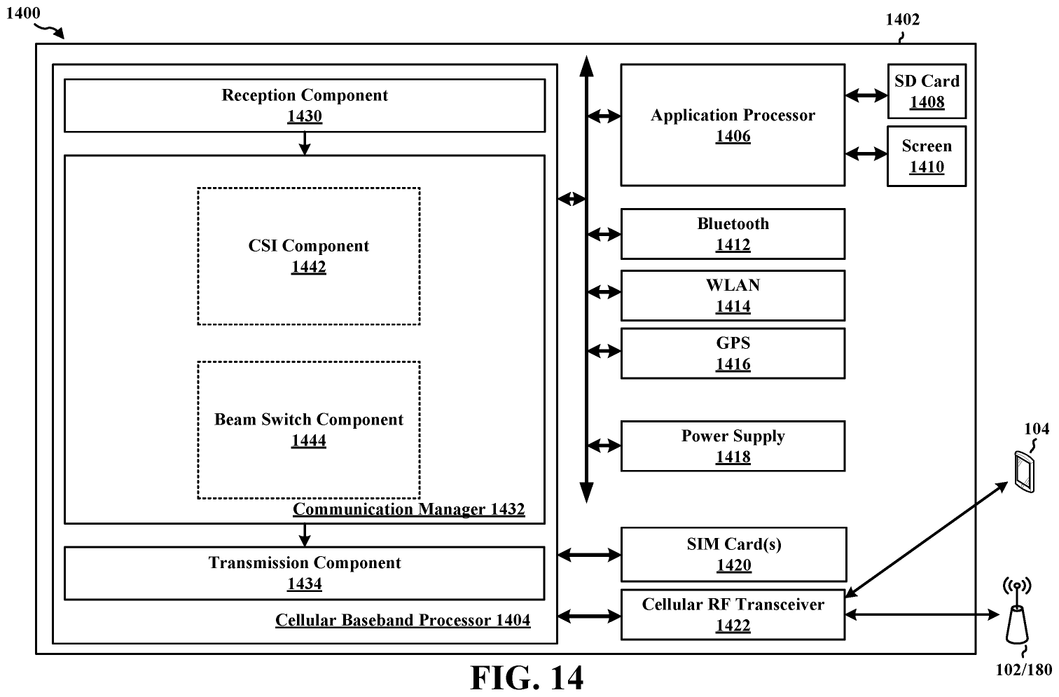

At 1002, the UE may transmit, to a base station, a CSI report associated with a beam switch. For example, the UE 702 may transmit, to a base station 704, a CSI report 751 associated with a beam switch. In some aspects, 1002 may be performed by the CSI component 1442 of FIG. 14.

At 1004, the UE may perform the beam switch based on the CSI report and an absence, for a period of time after transmission of the CSI report, of a DCI including a TCI indication. For example, the UE 702 may perform the beam switch based on the CSI report and an absence, for a period of time after transmission of the CSI report, of a DCI including a TCI indication (such as the DCI 703). In some aspects, 1004 may be performed by the beam switch component 1444 of FIG. 14. In some aspects, the CSI report indicates a RS associated with the beam switch, and the UE performs the beam switch based on the absence of the DCI including the TCI indication for a set of channels or a set of RSs comprising the RS. In some aspects, the CSI report indicates a RS associated with the beam switch, and the UE performs the beam switch based on the absence of the DCI including the TCI indication for a set of channels or a set of RSs applicable to a TCI state associated with the RS associated with the CSI report. In some aspects, the UE performs the beam switch based on the absence of the DCI that indicates a rejection of the beam switch.

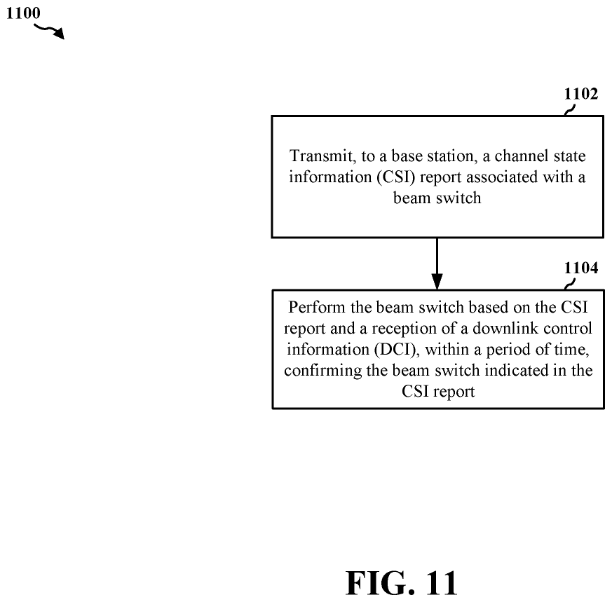

FIG. 11 is a flowchart 1100 of a method of wireless communication. The method may be performed by a UE (e.g., the UE 104, the UE 702, other UEs; the apparatus 1402). The method may be used for improving reliability of an implicit beam switch.

At 1102, the UE may transmit, to a base station, a CSI report associated with a beam switch. For example, the UE 802 may transmit, to a base station 804, a CSI report 801 associated with a beam switch. In some aspects, 1102 may be performed by the CSI component 1442 of FIG. 14.

At 1104, the UE may perform the beam switch based on the CSI report and a reception of a DCI, within a period of time, confirming the beam switch indicated in the CSI report. For example, the UE 802 may perform the beam switch based on the CSI report and a reception of a DCI 803, within a period of time, confirming the beam switch indicated in the CSI report. In some aspects, 1104 may be performed by the beam switch component 1444 of FIG. 14. In some aspects, the DCI indicates a TCI corresponding to a RS associated with the CSI report associated with the beam switch. In some aspects, the DCI may include one or more bits confirming the beam switch, and the period of time may be based on an end of the transmission of the CSI report. In some aspects, the DCI may include one or more bits confirming the beam switch, and the period of time may be based on an end of the reception of the DCI.

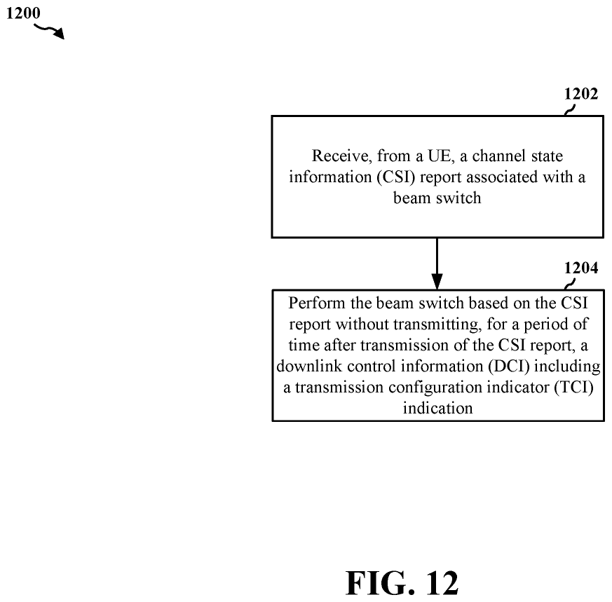

FIG. 12 is a flowchart 1200 of a method of wireless communication. The method may be performed by a base station (e.g., the base station 102/180, the base station 704, other base stations; the apparatus 1502). The method may be used for improving reliability of an implicit beam switch.

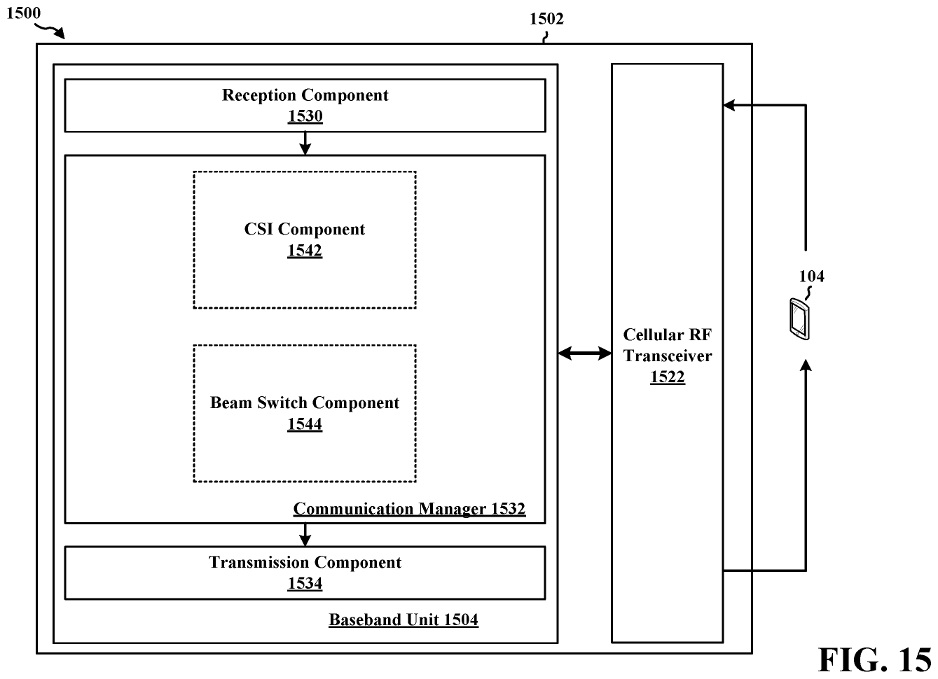

At 1202, the base station may receive, from a UE, a CSI report associated with a beam switch. For example, the base station 704 may receive, from a UE 702, a CSI report 751 associated with a beam switch. In some aspects, 1202 may be performed by the CSI component 1542 of FIG. 15.

At 1204, the base station may perform the beam switch based on the CSI report without transmitting, for a period of time after transmission of the CSI report, a DCI including a TCI indication. For example, the base station 704 may perform the beam switch based on the CSI report without transmitting, for a period of time after transmission of the CSI report, a DCI including a TCI indication (such as the DCI 703). In some aspects, 1204 may be performed by the beam switch component 1544 of FIG. 15. In some aspects, the CSI report may indicate a RS associated with the beam switch, and the base station may perform the beam without transmitting the DCI including the TCI indication for a set of channels or a set of RSs comprising the RS. In some aspects, the CSI report may indicate a RS associated with the beam switch, and the base station may perform the beam without transmitting the DCI including the TCI indication for a set of channels or a set of RSs applicable to a TCI state associated with the RS associated with the CSI report. In some aspects, the base station may perform the beam without transmitting the DCI that indicates a rejection of the beam switch.

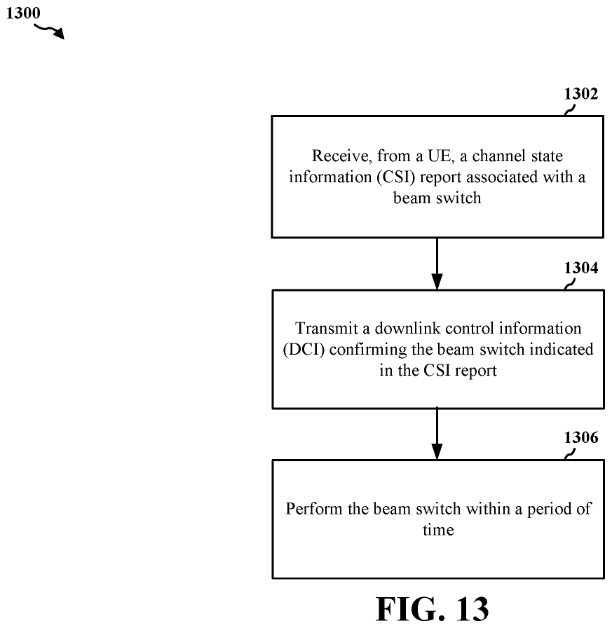

FIG. 13 is a flowchart 1300 of a method of wireless communication. The method may be performed by a base station (e.g., the base station 102/180, the base station 804, other base stations; the apparatus 1502). The method may be used for improving reliability of an implicit beam switch.

At 1302, the base station may receive, from a UE, a CSI report associated with a beam switch. For example, the base station 804 may receive, from a UE 802, a CSI report 801 associated with a beam switch. In some aspects, 1302 may be performed by the CSI component 1542 of FIG. 15.

At 1304, the base station may transmit a DCI confirming the beam switch indicated in the CSI report. For example, the base station 804 may transmit a DCI 803 confirming the beam switch indicated in the CSI report. In some aspects, 1304 may be performed by the beam switch component 1544 of FIG. 15.

At 1306, the base station may perform the beam switch within a period of time. For example, the base station 804 may perform the beam switch within a period of time on the downlink channels 805 or the uplink channels 807. In some aspects, 1306 may be performed by the beam switch component 1544 of FIG. 15. In some aspects, the DCI indicates a TCI corresponding to a RS associated with the CSI report associated with the beam switch. In some aspects, the DCI may include one or more bits confirming the beam switch, and the period of time may be based on an end of the reception of the CSI report. In some aspects, the DCI may include one or more bits confirming the beam switch, and the period of time may be based on an end of the transmission of the DCI.

FIG. 14 is a diagram 1400 illustrating an example of a hardware implementation for an apparatus 1402. The apparatus 1402 may be a UE, a component of a UE, or may implement UE functionality. In some aspects, the apparatus 1402 may include a cellular baseband processor 1404 (also referred to as a modem) coupled to a cellular RF transceiver 1422. In some aspects, the apparatus 1402 may further include one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, or a power supply 1418. The cellular baseband processor 1404 communicates through the cellular RF transceiver 1422 with the UE 104 and/or BS 102/180. The cellular baseband processor 1404 may include a computer-readable medium/memory. The computer-readable medium/memory may be non-transitory. The cellular baseband processor 1404 is responsible for general processing, including the execution of software stored on the computer-readable medium/memory. The software, when executed by the cellular baseband processor 1404, causes the cellular baseband processor 1404 to perform the various functions described supra. The computer-readable medium/memory may also be used for storing data that is manipulated by the cellular baseband processor 1404 when executing software. The cellular baseband processor 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the cellular baseband processor 1404. The cellular baseband processor 1404 may be a component of the UE 350 and may include the memory 360 and/or at least one of the TX processor 368, the RX processor 356, and the controller/processor 359. In one configuration, the apparatus 1402 may be a modem chip and include just the cellular baseband processor 1404, and in another configuration, the apparatus 1402 may be the entire UE (e.g., see 350 of FIG. 3) and include the additional modules of the apparatus 1402.

The communication manager 1432 may include a CSI component 1442 that is configured to transmit, to a base station, a CSI report associated with a beam switch, e.g., as described in connection with 1002 in FIGS. 10 and 1102 in FIG. 11. The communication manager 1432 may further include a beam switch component 1444 that may be configured to perform the beam switch, e.g., as described in connection with 1004 in FIGS. 10 and 1104 in FIG. 11.

The apparatus may include additional components that perform each of the blocks of the algorithm in the flowcharts of FIGS. 10-11. As such, each block in the flowcharts of FIGS. 10-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the cellular baseband processor 1404, may include means for transmitting, to a base station, a CSI report associated with a beam switch. The cellular baseband processor 1404 may further include means for performing the beam switch based on the CSI report and an absence, for a period of time after transmission of the CSI report, of a DCI including a TCI indication. The cellular baseband processor 1404 may further include means for performing the beam switch based on the CSI report and a reception of a DCI, within a period of time, confirming the beam switch indicated in the CSI report. The cellular baseband processor 1404 may further include means for receiving the DCI. The means may be one or more of the components of the apparatus 1402 configured to perform the functions recited by the means. As described supra, the apparatus 1402 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 15 is a diagram 1500 illustrating an example of a hardware implementation for an apparatus 1502. The apparatus 1502 may be a base station, a component of a base station, or may implement base station functionality. In some aspects, the apparatus 1402 may include a baseband unit 1504. The baseband unit 1504 may communicate through a cellular RF transceiver 1522 with the UE 104. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the base station 310 and may include the memory 376 and/or at least one of the TX processor 316, the RX processor 370, and the controller/processor 375.

The communication manager 1532 may include a CSI component 1542 that may receive, from a UE, a CSI report associated with a beam switch, e.g., as described in connection with 1202 in FIGS. 12 and 1302 in FIG. 13. The communication manager 1532 further may include a beam switch component 1544 that may perform the beam switch or transmit a DCI confirming the beam switch indicated in the CSI report, e.g., as described in connection with 1204 in FIGS. 12 and 1304/1306 in FIG. 13.

The apparatus may include additional components that perform each of the blocks of the algorithm in the flowcharts of FIGS. 12-13. As such, each block in the flowcharts of FIGS. 12-13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the baseband unit 1504, may include means for receiving, from a UE, a CSI report associated with a beam switch. The baseband unit 1504 may further include means for performing the beam switch based on the CSI report without transmitting, for a period of time after transmission of the CSI report, a DCI including a TCI indication. The baseband unit 1504 may further include means for transmitting a DCI confirming the beam switch indicated in the CSI report. The baseband unit 1504 may further include means for performing the beam switch within a period of time. The means may be one or more of the components of the apparatus 1502 configured to perform the functions recited by the means. As described supra, the apparatus 1502 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE, comprising: a memory; and at least one processor coupled to the memory and configured to: transmit, to a base station, a CSI report associated with a beam switch; and perform the beam switch based on the CSI report and an absence, for a period of time after transmission of the CSI report, of a DCI including a TCI indication.

Aspect 2 is the apparatus of aspect 1, wherein the CSI report indicates a RS associated with the beam switch, and wherein the UE performs the beam switch based on the absence of the DCI including the TCI indication for a set of channels or a set of RSs comprising the RS.

Aspect 3 is the apparatus of any of aspects 1-2, wherein the CSI report indicates a RS associated with the beam switch, and wherein the UE performs the beam switch based on the absence of the DCI including the TCI indication for a set of channels or a set of RSs applicable to a TCI state associated with the RS associated with the CSI report.

Aspect 4 is the apparatus of any of aspects 1-3, wherein the UE performs the beam switch based on the absence of the DCI that indicates a rejection of the beam switch.

Aspect 5 is an apparatus for wireless communication at a UE, comprising: a memory; and at least one processor coupled to the memory and configured to: transmit, to a base station, a CSI report associated with a beam switch; and perform the beam switch based on the CSI report and a reception of a DCI, within a period of time, confirming the beam switch indicated in the CSI report.

Aspect 6 is the apparatus of aspect 5, wherein the DCI indicates a TCI corresponding to a RS associated with the CSI report associated with the beam switch.

Aspect 7 is the apparatus of any of aspects 5-6, wherein the DCI comprises one or more bits confirming the beam switch, and wherein the period of time is based on an end of the transmission of the CSI report.

Aspect 8 is the apparatus of any of aspects 5-7, wherein the DCI comprises one or more bits confirming the beam switch, and wherein the period of time is based on an end of the reception of the DCI.

Aspect 9 is an apparatus for wireless communication at a base station, comprising: a memory; and at least one processor coupled to the memory and configured to: receive, from a UE, a CSI report associated with a beam switch; and perform the beam switch based on the CSI report without transmitting, for a period of time after transmission of the CSI report, a DCI including a TCI indication.

Aspect 10 is the apparatus of aspect 9, wherein the CSI report indicates a RS associated with the beam switch, and wherein the base station performs the beam without transmitting the DCI including the TCI indication for a set of channels or a set of RSs comprising the RS.

Aspect 11 is the apparatus of any of aspects 9-10, wherein the CSI report indicates a RS associated with the beam switch, and wherein the base station performs the beam without transmitting the DCI including the TCI indication for a set of channels or a set of RSs applicable to a TCI state associated with the RS associated with the CSI report.

Aspect 12 is the apparatus of any of aspects 9-11, wherein the base station performs the beam without transmitting the DCI that indicates a rejection of the beam switch.

Aspect 13 is an apparatus for wireless communication at a base station, comprising: a memory; and at least one processor coupled to the memory and configured to: receive, from a UE, a CSI report associated with a beam switch; transmit a DCI confirming the beam switch indicated in the CSI report; and perform the beam switch within a period of time.

Aspect 14 is the apparatus of aspect 13, wherein the DCI indicates a TCI corresponding to a RS associated with the CSI report associated with the beam switch.

Aspect 15 is the apparatus of any of aspects 13-14, wherein the DCI comprises one or more bits confirming the beam switch, and wherein the period of time is based on an end of the reception of the CSI report.

Aspect 16 is the apparatus of any of aspects 13-15, wherein the DCI comprises one or more bits confirming the beam switch, and wherein the period of time is based on an end of the transmission of the DCI.

Aspect 17 is a method of wireless communication for implementing any of aspects 1 to 4.

Aspect 18 is an apparatus for wireless communication including means for implementing any of aspects 1 to 4.

Aspect 19 is a computer-readable medium storing computer executable code, where the code when executed by a processor causes the processor to implement any of aspects 1 to 4.

Aspect 20 is a method of wireless communication for implementing any of aspects 5 to 8.

Aspect 21 is an apparatus for wireless communication including means for implementing any of aspects 5 to 8.

Aspect 22 is a computer-readable medium storing computer executable code, where the code when executed by a processor causes the processor to implement any of aspects 5 to 8.

Aspect 23 is a method of wireless communication for implementing any of aspects 9 to 12.

Aspect 24 is an apparatus for wireless communication including means for implementing any of aspects 9 to 12.

Aspect 25 is a computer-readable medium storing computer executable code, where the code when executed by a processor causes the processor to implement any of aspects 9 to 12.

Aspect 26 is a method of wireless communication for implementing any of aspects 13 to 16.

Aspect 27 is an apparatus for wireless communication including means for implementing any of aspects 13 to 16.

Aspect 28 is a computer-readable medium storing computer executable code, where the code when executed by a processor causes the processor to implement any of aspects 13 to 16.

What is claimed is:

1. An apparatus for wireless communication at a user equipment (UE), comprising:
a memory; and
at least one processor coupled to the memory and configured to:
transmit, to a base station, a channel state information (CSI) report associated with a beam switch; and
perform the beam switch based on the CSI report and an absence, for a period of time after transmission of the CSI report, of a downlink control information (DCI) including a transmission configuration indicator (TCI) indication.

2. The apparatus of claim 1, wherein the CSI report indicates a reference signal (RS) associated with the beam switch, and wherein the UE performs the beam switch based on the absence of the DCI including the TCI indication for a set of channels or a set of reference signals (RSs) comprising the RS.

3. The apparatus of claim 1, wherein the CSI report indicates a reference signal (RS) associated with the beam switch, and wherein the UE performs the beam switch based on the absence of the DCI including the TCI indication for a set of channels or a set of reference signals (RSs) applicable to a TCI state associated with the RS associated with the CSI report.

4. The apparatus of claim 1, wherein the UE performs the beam switch based on the absence of the DCI that indicates a rejection of the beam switch.

5. An apparatus for wireless communication at a user equipment (UE), comprising:
a memory; and
at least one processor coupled to the memory and configured to:
transmit, to a base station, a channel state information (CSI) report associated with a beam switch; and
perform the beam switch based on the CSI report and a reception of a downlink control information (DCI), within a period of time, confirming the beam switch indicated in the CSI report.

6. The apparatus of claim 5, wherein the DCI indicates a transmission configuration indicator (TCI) corresponding to a reference signal (RS) associated with the CSI report associated with the beam switch.

7. The apparatus of claim 5, wherein the DCI comprises one or more bits confirming the beam switch, and wherein the period of time is based on an end of the transmission of the CSI report.

8. The apparatus of claim 5, wherein the DCI comprises one or more bits confirming the beam switch, and wherein the period of time is based on an end of the reception of the DCI.

9. An apparatus for wireless communication at a base station, comprising:
a memory; and
at least one processor coupled to the memory and configured to:
receive, from a UE, a channel state information (CSI) report associated with a beam switch; and
perform the beam switch based on the CSI report without transmitting, for a period of time after transmission of the CSI report, a downlink control information (DCI) including a transmission configuration indicator (TCI) indication.

10. The apparatus of claim 9, wherein the CSI report indicates a reference signal (RS) associated with the beam switch, and wherein the base station performs the beam without transmitting the DCI including the TCI indication for a set of channels or a set of reference signals (RSs) comprising the RS.

11. The apparatus of claim 9, wherein the CSI report indicates a reference signal (RS) associated with the beam switch, and wherein the base station performs the beam without transmitting the DCI including the TCI indication for a set of channels or a set of reference signals (RSs) applicable to a TCI state associated with the RS associated with the CSI report.

12. The apparatus of claim 9, wherein the base station performs the beam without transmitting the DCI that indicates a rejection of the beam switch.

13. An apparatus for wireless communication at a base station, comprising:
a memory; and
at least one processor coupled to the memory and configured to:
receive, from a UE, a channel state information (CSI) report associated with a beam switch;
transmit a downlink control information (DCI) confirming the beam switch indicated in the CSI report; and
perform the beam switch within a period of time.

14. The apparatus of claim 13, wherein the DCI indicates a transmission configuration indicator (TCI) corresponding to a reference signal (RS) associated with the CSI report associated with the beam switch.

15. The apparatus of claim 13, wherein the DCI comprises one or more bits confirming the beam switch, and wherein the period of time is based on an end of the reception of the CSI report.

16. The apparatus of claim 13, wherein the DCI comprises one or more bits confirming the beam switch, and wherein the period of time is based on an end of the transmission of the DCI.

17. A method for wireless communication at a user equipment (UE), comprising:
transmitting, to a base station, a channel state information (CSI) report associated with a beam switch; and
performing the beam switch based on the CSI report and an absence, for a period of time after transmission of the CSI report, of a downlink control information (DCI) including a transmission configuration indicator (TCI) indication.

18. The method of claim 17, wherein the CSI report indicates a reference signal (RS) associated with the beam switch, and wherein the UE performs the beam switch based on the absence of the DCI including the TCI indication for a set of channels or a set of reference signals (RSs) comprising the RS.

19. The method of claim 17, wherein the CSI report indicates a reference signal (RS) associated with the beam switch, and wherein the UE performs the beam switch based on the absence of the DCI including the TCI indication for a set of channels or a set of reference signals (RSs) applicable to a TCI state associated with the RS associated with the CSI report.

20. The method of claim 17, wherein the UE performs the beam switch based on the absence of the DCI that indicates a rejection of the beam switch.
